(19) United States
(12) Patent Application Publication
(10) Pub. No.: US 2014/0308649 A1
(43) Pub. Date: Oct. 16, 2014

(54) CUMULATIVE TESTS IN EDUCATIONAL ASSESSMENT

(71) Applicant: Assessment Technology Incorporated, Tucson, AZ (US)

(72) Inventors: John Richard Bergan, Tucson, AZ (US); Christopher S. Johnson, Tucson, AZ (US); John Robert Bergan, Tucson, AZ (US); Christine G. Burnham, Tucson, AZ (US); Sarah M. Callahan, Tucson, AZ (US)

(73) Assignee: Assessment Technology Incorporated, Tucson, AZ (US)

(21) Appl. No.: 14/250,724

(22) Filed: Apr. 11, 2014

Related U.S. Application Data
(60) Provisional application No. 61/811,083, filed on Apr. 11, 2013.

(51) Int. Cl. G09B 7/00

(52) U.S. Cl. CPC G09B 7/00
USPC 434/362

(57) ABSTRACT

New methods and systems are disclosed for improved assessments of student progress in education. Using a new concept called a cumulative test, examinee ability may be measured by combining discrete measures into one test representing ability measured over an extended period of time. (FIG. 1.) Many assessment items and corresponding responses from various different test forms may contribute to a cumulative test. The discrete or “snapshot” tests taken into account preferably are given over an extended period such as a school year, in different classes, schools and even districts. (FIG. 2.) There is no requirement that examinees take the same items or any particular set of items to implement the cumulative test. Item Response Theory (IRT) may be used to estimate ability scores for cumulative tests (FIG. 3.).

### RELATED APPLICATIONS

This application is a non-provisional of U.S. Provisional Application No. 61/811,083 filed Apr. 11, 2013 and incorporated herein by this reference.

### COPYRIGHT NOTICE

© 2013-2014 Assessment Technology, Inc. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This invention pertains to methods and apparatus in the field of educational testing.

### BACKGROUND OF THE INVENTION

Educational testing has increased dramatically in recent years. Both the number of student assessments and the types of assessments provided for students have grown extensively. These changes have produced significant challenges for the testing industry and for schools implementing assessments. In the past, test development was a slow process controlled in the main by test developers. Today, rapid ongoing test development driven by continually changing educator needs is the norm. The result is an accumulation of tests comprised of many closely related assessments administered to many groups of students at many different times.

The demands associated with the construction of high quality assessments in the current educational environment are significant. In many cases the number of students taking a test is too small to support adequate psychometric analyses. Test length is also a major issue. Tests that take longer than one class period to administer pose a scheduling challenge for schools. Yet, tests administered in one class period often do not provide the degree of measurement precision that can be obtained from a longer assessment. In addition, short tests typically provide only limited coverage of the underlying ability that the test is designed to measure.

### SUMMARY OF THE INVENTION

The following is a summary of the invention in order to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later.

Conventional testing attempts to assess a student's ability in a given subject or content area at a given point in time—the test date. The same test could be repeated at a later date, to try to assess progress, but because the student has seen the test items before, the accuracy of test results are eroded. Equivalent test items could be substituted. Put another way, the prior art divided continuous assessment into discrete periods. In this application, we combine discrete assessments into a continuous whole. Thus, we describe how to assess a student's ability over a period of time, say a whole school year, rather than at a point in time. Rather than simply add up discrete test scores, or average them over a school year, we describe a new approach, called Cumulative Tests, to provide a longer term assessment with substantially improved accuracy, as explained below.

This document presents a new cumulative approach to test development, test scoring, test analysis, and test reporting. The introduction of Cumulative tests into educational assessment produces many potential benefits. A Cumulative test makes it possible to use all of the available data for parameter estimation. The responses of all students responding to a given item can be considered in estimating parameters for that item. Cumulative Tests provide an increasing amount of data as time passes. Thus, the precision of estimates of ability improves as students respond to an increasing number of items. A Cumulative Test provides massive amounts of information that can be used to guide instruction when a large number of items are included in the assessment. A Cumulative Test has the potential to improve forecasting accuracy because it facilitates the use of all of the available data in making the forecast. Cumulative Tests support the measurement of growth from customized assessments aligned with district curricula because they provide extremely broad coverage of the knowledge and skills to be acquired through instruction.

Additional aspects and advantages of this invention will be apparent from the following detailed description of preferred embodiments, which proceeds with reference to the accompanying drawings.

### BRIEF DESCRIPTION OF THE DRAWINGS

FIG. 1 is a simplified flow diagram of a process for selecting and analyzing test data acquired from multiple assessments over time as a single cumulative test construct.

FIG. 2 is a simplified flow diagram of a process for accumulating test results data in a database to support construction of cumulative tests.

FIG. 3 is a simplified flow diagram of a process for constructing a cumulative test and scoring student proficiency.

### DETAILED DESCRIPTION OF PREFERRED EMBODIMENTS

Educational assessments are created to report on what students know and can do. Although any test consists of a specific set of test items, the information we seek about student proficiency is general and the specific test items are intended to support conclusions about more broadly defined areas of student proficiency. The proficiency we assess in a subject area may be thought of as not directly observable and measurable; instead, it may be imperfectly measured by observing student responses to test items.

When we say that we wish or require that a student or all students be proficient in reading, for example, defining what is meant by proficiency is of great importance. In modern educational measurement theory and practice, proficiency is considered to be a psychological construct, operationally defined as the unobserved (“latent”) variable that explains individual differences in performance on the observable set of measures (e.g., reading test items). Establishing the relevance of the observable measures for supporting inferences regarding the psychological construct is a primary goal of test validation.

The latent proficiency variable is defined by a specific statistical model (e.g., item response theory model or classical test theory model) that describes how observable responses depend on those proficiencies. Because these statistical models enable us to estimate and assign numerical values for proficiency given an examinee's responses to test items, they are appropriately called measurement models. Below we describe measurement modeling for a cumulative test. Scaling refers to the establishment of units for reporting measures of proficiency, and scaling occurs in conjunction with the identification of measurement models.

A “cumulative test” historically was thought of as test that covers the full range of content in a course of study. A final exam, for example, might have been called a cumulative test. Aside from the range of content covered, a cumulative test historically was similar to any other test. That is, it comprised one test given to a group of examinees at one time.

Here we introduce a new and different cumulative construct in the field of assessments. A Cumulative Test, as described here, is typically comprised of examinee responses to items from many tests, that were administered in many sessions to many groups of examinees over an extended time period. While perhaps a bit of a misnomer, a Cumulative Test as we define it in this patent application is not a test in the conventional sense of discrete tests, because, for example, it is not administered to any test taker, and it preferably includes many more test items then any individual would be expected to respond to within a reasonable time. Rather, our new Cumulative Test it is a novel analytic tool for mining information from a plurality of discrete test results in a new way. From this point on, the term cumulative test will be used to refer to this new construct.

In the limiting case, a cumulative test will include examinee responses to items from two tests administered in two sessions on two occasions. A given examinee can be expected to respond to some number of test items, but is not likely to respond to all of the items comprising the cumulative test. To qualify as an examinee, an individual must respond to at least one item on the cumulative test.

The cumulative test innovation builds on earlier work included in ATI's U.S. Pat. No. 6,322,366 titled Instructional Management System, incorporated herein by this reference. The ATI Instructional Management System includes an assessment component that provides a “continuous record of development that can be flexibly segmented into discrete periods for the purpose of documenting progress.” The cumulative test also provides a continuous record of development that can be used to measure progress. However, whereas the earlier work divided continuous assessment into discrete periods, the present application combines discrete assessments into a continuous whole.

The concept of a cumulative test as defined here represents an innovation in educational measurement with implications for item parameter estimation, student ability estimation, and forecasting of student performance on other related tests (e.g., statewide assessments). The cumulative test approach represents a shift in the conception of student ability from a point in time estimate to one that spans a time period. A cumulative test is assumed to measure a single latent ability. However, sets of items on the test may also reflect specific factors in addition to that ability.

The approach supports a conception of student ability reflecting instruction and assessment throughout a defined period of instruction. For example, a cumulative test may reflect instruction during an entire school year for a grade and content area. Likewise, a cumulative test may represent instructional content for an entire course such as advanced algebra, but it differs from discrete or “point-in-time” assessments. For example, historically, teachers have given various tests, quizzes, etc. At the end of the term, in some cases, they may sum or average (perhaps with weighting) those results, to combine them and arrive at a final score. That was not a cumulative test. Rather, in this example, the teacher was summing or averaging scores from many tests, not creating one test. In addition, the teacher is not using Item Response Theory (IRT) as we do. As a consequence, the teacher cannot measure growth. Cumulative tests are scored using IRT as explained below. Thus, a scale score can be estimated at any time during the year. Moreover, scale scores can be estimated at multiple times. This makes it possible to measure growth.

The cumulative test approach takes advantage of information gained from student responses to large numbers of items administered throughout an extended time period as part of multiple tests with varying purposes. This approach preferably uses most or all of the available information about a given student related to a given course of study to provide increasingly precise estimates of student ability, information about student growth, and information about student standards mastery that can be used to guide instruction. The cumulative test approach also has benefits related to the application of statistical procedures typically used in educational measurement. For example, in item parameter estimation, this approach makes use of responses from a very large population of students to a very large set of items to increase the precision and stability of parameter estimates for individual items. In this regard, improved parameter estimates may be provided to a test item database for use in improving discrete tests. Similarly, in forecasting, this approach makes use of data from a very large population of students to increase accuracy.

A cumulative test could be constructed by conducting an analysis of the instructional content to be covered and building a series of discrete tests covering the designated content. However, there are other options. A unique feature of our approach to test construction is that it supports the development of cumulative tests designed to meet the specific assessment requirements of the user. In one example, a user may begin the process of test design by filling out a test order form, which may be electronic (on-line). The order form preferably specifies for a given user all of the tests to be constructed during the school year and the projected draft test creation, test review, final test creation, and test delivery dates for the specified assessments. For example, a user may order tests in math, English language arts, and science to be administered four times during the school year in grades three through ten. In this example, the user would be able to order 96 assessments at one time and receive the projected dates for the creation, review, and delivery of each of the 96 assessments. The information provided through the Order Form is transmitted to the Assessment Planner, which enables the user to specify the standards to be covered on each test on the number of items for each standard. Upon receipt of the assessment plans, a series of draft assessments are automatically constructed for all 96 assessments using the Generate Test feature. The user may review the draft assessments and replace items with alternatives preferred by the user. The final assessment is then constructed and delivered to the user in a secure storage library. This type of process supports the efficient development of tests designed by users. Thus, the cumulative tests constructed from our assessments reflect the capabilities that educators from hundreds of districts deem important to assess.

Example for Constructing a Cumulative Test

Cumulative Test construction may be initiated by creating an examinee by item matrix, with examinees as columns and items as rows. We use the term “items” herein to refer to student assessment items, such as test or quiz questions. Thus, for example, a given item may be a true/false question, a multiple-choice question, etc. The term “matrix” is a well known concept, referring herein to any machine-implemented data storage and manipulation technique, comprising hardware and or software, capable of storing a multi-dimensional dataset. A relational database could be used. The items included in the matrix come from multiple user-designed assessments. Here we use the term “user” to refer to a teacher, administrator, or other school, school district or state education department employee or contractor who participates in the design, creation and/or analysis of student assessments. Each intersection of a row and column defines a corresponding cell of the matrix.

In an embodiment, each cell may contain the following information: A blank cell may be used indicating that the examinee made no response to the item, or an ordinal number indicating the examinee score on the item. For binary items (true/false), the cell score could be a zero indicating an incorrect response, or a one indicating a correct response. The score for polytomous items may range from 0, 1, 2, . . . n, where n is a positive integer. Item scores in this context are not continuous. There are no decimals. A continuous interval scale score for the cumulative test may be estimated using IRT as further explained below. Other indicators of scores may be used for equivalent purposes.

When the items-by-examinee matrix is created, items lose their discrete-test membership. A three-dimensional matrix (items×examinees×Test IDs) would be required to retain item membership in a discrete test, but that would be unnecessary in a preferred embodiment. The primary purpose of the matrix is to link items to examinees in one matrix, which captures all of the information needed to produce a cumulative test.

These assessments preferably contain items administered to examinees over an entire school year or over multiple years. Multi-year cumulative tests could be developed to accommodate a multi-year course of study. Items included in the matrix are selected based on their membership in a defined class. For example, item selection might be limited to a particular subject, grade level, and time span. Examinee selection is also based on class membership. For instance, examinee selection might be limited to a particular age, grade level, time period, and/or to participation in a specified course of instruction. As is the case with any test, duplicate items should be avoided. Duplicates may be avoided in a Cumulative Test by imposing the rule during test generation that no item used in a Cumulative Test may be made available for administration to the same student on more than one occasion. Automated technology is available to support the generation of a series of tests without duplicate items.

To illustrate the new concept, we constructed a Cumulative Test designed to measure third-grade English Language Arts (ELA) ability. This Cumulative Test is comprised of 1,000 items. Benchmark tests containing these items were administered to 74,711 students during one school year. Thus, the illustrative matrix is comprised of 74, 711 rows and 1,000 columns. The sum for a given row indicates the number of items responded to by a given student. A column sum gives the number of students who have responded to a given item. In the illustrative matrix, the minimum number of items responded to by a student is 1. The minimum is affected by periodic removal of bank items associated with various factors such as changing standards. The maximum is 394. The average number of items responded to by a student is 133.23, and the standard deviation is 50.07. Measurement precision is a direct function of test length. The large number of items responded to by students is consistent with high levels of measurement precision.

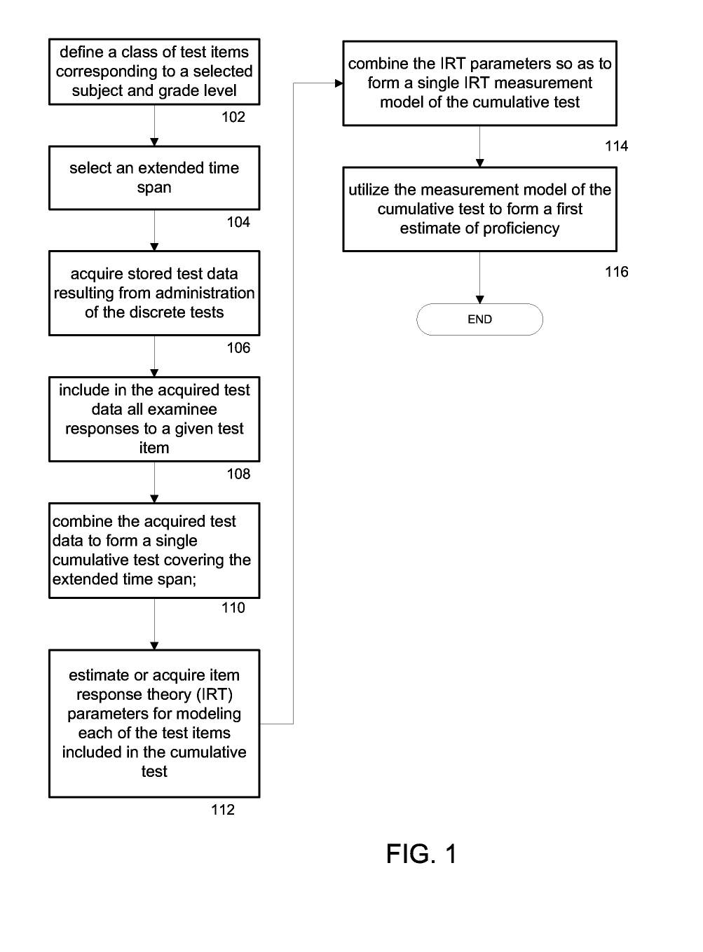

FIG. 1 is a simplified flow diagram of an illustrative process for selecting and analyzing test data acquired from multiple assessments over time as a single cumulative test. In FIG. 1, the illustrated steps are: define a class of test items corresponding to a selected subject and grade level, block 102; select an extended time span, block 104; acquire stored test data resulting from administration of the discrete tests, block 106; include in the acquired test data all examinee responses to a given test item, block 108; combine the acquired test data to form a single cumulative test covering the extended time span, block 110; estimate or acquire item response theory (IRT) parameters for modeling each of the test items included in the cumulative test, block 112; combine the IRT parameters so as to form a single IRT measurement model of the cumulative test, block 114; and utilize the measurement model of the cumulative test to form a first estimate of proficiency, block 116.

In general, our computer-implemented process for constructing cumulative tests can produce multiple cumulative assessments containing thousands of items administered to tens of thousands of examinees in a highly efficient and cost effective manner. For example, a staff of four professionals can produce tens of thousands of discrete tests that are combined automatically into cumulative tests using the matrix technology described above. In one practical implementation, database programmers were asked, for a given grade and subject, to search item banks aligning items to specifications and specifications to standards, and to search a question-answer table to obtain all examinee responses to a given item. From that information the item×examinee matrix for a given subject and grade was created. Various optimizations can be used to reduce query time. A user interface may be constructed to enable a user to easily specify a desired matrix.

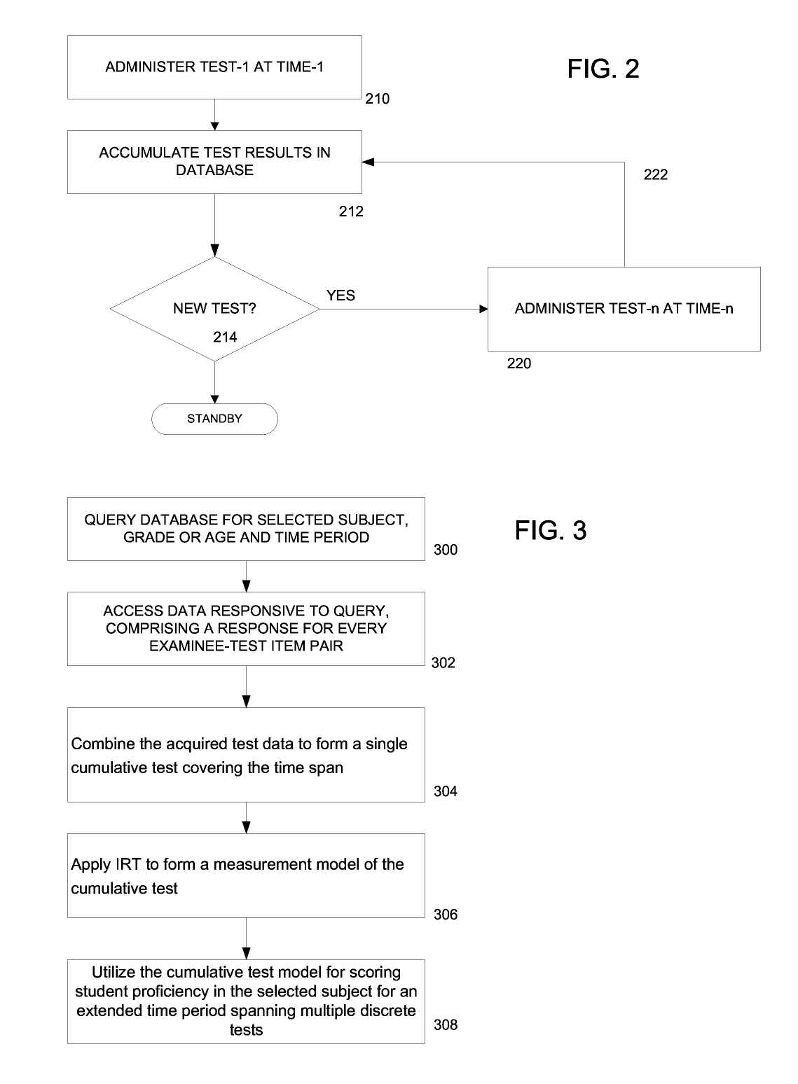

FIG. 2 is a simplified flow diagram of a process for accumulating test results data in a database to support construction of cumulative tests. In FIG. 2, the process steps are: administer a test, block 210; accumulate the test results in the database, block 212; check for a new test, decision 214; and if so, administer the next test, block 220. After each test, the process loops back via path 222 to store the new test results in the database, repeating step 212, etc.

Cumulative Test Item Parameter Estimation

Item parameter estimation for a Cumulative Test may be accomplished in a single analysis involving numerical analysis techniques implemented using Item Response Theory (IRT). In the illustrative analysis, three item parameters (a difficulty parameter, discrimination parameter, and pseudo guessing parameter) were estimated for each of the 1,000 items in the Cumulative Test yielding a total of 3,000 parameter estimates. A uni-dimensional model was assumed for the illustration. However, multidimensional models may also be implemented. A standard normal ability distribution was assumed under the model. Thus, the mean and standard deviation of the distribution were fixed at 0 and 1 respectively. This three-parameter logistic model is suited to multiple-choice test items. Other models are known for binary (dichotomous) and other types of test items.

In an IRT model generally, item difficulty is placed on the same scale as examinee ability. In addition, item discrimination is a direct function of the standard deviation of the ability distribution. As a consequence, if the mean of the ability distribution varies, the item difficulty parameter estimates will vary. Likewise, if the standard deviation varies, the discrimination parameter estimates will vary. The use of a single ability distribution with a fixed mean and standard deviation covering student performance over an extended time span such as a school year ensures that the item parameters will remain invariant regardless of the time of year that examinees respond to the items. Parameter invariance supports the measurement of academic progress. For example, if item difficulty varied over time, ability would remain constant and the items would get easier as the year progressed. When item difficulty is fixed, changes in ability can be measured. Ability will increase as students are given more opportunities to learn.

A particularly important benefit of Cumulative Test parameter estimation is that it increases the stability and precision of item parameter estimates. The stability and precision of parameter estimates for a given item is a function of the number of examinees responding to the item. Cumulative Test estimation increases the number of opportunities to use examinee responses to any given item in the estimation process. For example, if a particular item were included on ten different assessments each given to 100 examinees, the number of examinees included in Cumulative Test parameter estimation would be 1,000. If parameter estimation were limited to responses on a single test, the number of examinee responses used in parameter estimation would be only 100.

Typically, precision of estimates of ability for examinees taking a Cumulative Test may vary. (Again, examinees do not literally take the cumulative test.) Initial levels of precision can be expected to be lower than later estimates because the number of items to which examinees responded will initially be smaller than estimates taken at a later point in time. Acceptable levels of precision can be expected when an examinee responds to between 35 and 50 items.

In general, a cumulative test supports greater measurement precision than a discrete snapshot test because it typically contains a larger number of items than a snapshot and because examinees will respond to more items than would be the case with a snapshot. This is a benefit to the cumulative test approach, but it is not a defining feature of the approach. A cumulative test is not just more accurate than a discrete test because there are more items. A cumulative test supports the measurement of a different construct than a snapshot can support. For example, a cumulative test including 1,500 items aligned to all of the standards comprising fourth-grade math measures fourth-grade-math ability reflected in student performance across the entire school year.

### Cumulative Test Scoring

IRT assumes that an estimate of student ability can be obtained from any set of items measuring the underlying latent variable of interest. Moreover, there is no requirement that each student assessed respond to the same items. In an embodiment, we apply these IRT assumptions to provide cumulative scores labeled CScores for schools. The number of different CScores available for Cumulative Tests is almost limitless. Two options are discussed here to illustrate the possibilities and benefits derived from Cumulative Test scoring options.

One option is to include all available data cumulatively in determining multiple student scores on a Cumulative Test. For example, a student might receive a score following an initial benchmark assessment. A new score including responses from both the initial test and a second benchmark would be provided after the second test. Cumulative scoring would continue for subsequent tests. A major benefit to this approach is that it can increase measurement precision dramatically. Measurement precision is a direct function of test length. For example, test reliability is directly impacted by test length. When multiple benchmark assessments are combined cumulatively, test reliability will increase. A second important benefit is that as the year progresses the cumulative scale score provides an increasingly thorough assessment of the latent variable under examination.

Another scoring option involves cumulative scoring not only for benchmark assessments, but also for formative assessments conducted to measure the effects of re-teaching interventions conducted following benchmark assessments. Benchmark assessments provide information to guide instruction. Re-teaching interventions use benchmark results to provide additional instruction related to standards that students have failed to master. Short formative assessments are often used to assess re-teaching effects. These tests are generally too short to yield adequate levels of measurement precision on their own. However, they will increase measurement precision when they are combined with a previous benchmark to form a Cumulative Test. Moreover, they may significantly affect validity related to forecasting performance on criterion measures such as statewide tests. To the extent that re-teaching is effective, failure to include re-teaching results may reduce forecasting accuracy.

FIG. 3 is a simplified flow diagram of an illustrative process for constructing a cumulative test and scoring student proficiency. In this process, the step are: query database for selected subject, grade or age and time period, block 300; access data responsive to query, comprising a response for every examinee-test item pair, block 302; combine the acquired test data to form a single cumulative test covering the time span, block 304; apply IRT to form a measurement model of the cumulative test, block 306; and utilize the cumulative test model for scoring student proficiency in the selected subject for an extended time period spanning multiple discrete tests, block 308.

### Cumulative Measures of Growth

As indicated above, in developing a Cumulative Test, a single ability distribution is assumed to represent a given latent variable such as fourth-grade math ability. Each ability score refers to a position with respect to that ability distribution. As a consequence, all Cumulative Test scores are placed on a common scale. This means that scores can be compared. For example, a score obtained early in the school year can be compared to a score obtained later in the year. The difference between the two scores provides an unbiased estimate of growth or change in ability over time. [my comment—even if different tests are given in the sense of different assessment items, as long as criteria are met.]

A Cumulative Test provides a unique approach to the measurement of growth because variations in position on a Cumulative Test ability distribution reflect not only individual differences in ability, but also changes in ability occurring over time. When ability is measured as a snapshot taken at a single point in time, the ability distribution reflects only individual differences in ability at the time that the test is administered. The amount of variability for a snapshot is likely to be smaller than the amount of variability reflecting both individual differences and changes occurring over time. Thus, the ability distribution for a Cumulative Test is likely to be sensitive to change across a broader range than would be the case with a snapshot assessment.

Vertical Scaling Compared

Cumulative Tests should not be confused with vertical scaling (See R. Patz 2007). Vertical scaling is not a requirement for the development or implementation of a cumulative test. It plays no role in defining the construct of a cumulative test. Item parameter estimates for a cumulative test can be obtained in a single analysis conducted without vertical scaling. Vertical scaling may be used in parameter estimation in those instances in which it may be convenient to apply that technique, but vertical scaling is not an essential ingredient of a cumulative test.

A cumulative test combines discrete tests into one test. The Patz paper does not suggest combining discrete tests into one test. Rather, Patz is concerned with placing the scores from discrete tests onto a common scale. Cumulative test scores obtained for a given cumulative test are scores on that test. The scores can be compared because they are scores on the same test. That said, it is important to note that there is no requirement that examinees take the same items or any particular set of items. Item Response Theory (IRT) may used to estimate ability scores for cumulative tests.

### Cumulative Tests and Instructional Guidance

The major purpose of assessment in education is to provide information that can be used to guide instruction. Cumulative Tests combined with IRT offer significant advantages over other approaches with respect to instructional guidance. When parameters have been estimated using IRT, it is possible to estimate the probability that a given item will be responded to correctly by a student at a given ability level. For example, for a three-parameter IRT model, the probability (π) of a correct response given ability (θ) is:

$${π}_{i = 1} \vert θ = {c}_{i} + \frac{1 - {c}_{i}}{1 + {e}^{- {a}_{i} ( θ - {b}_{i} )}} ;$$

Where cᵢ is the pseudo guessing parameter for item i, aᵢ is the discrimination parameter for item i, and bᵢ is the difficulty parameter for item i.

When ability has been estimated for a student or a group of students, the probability of responding correctly to all items included in the Cumulative Test can be estimated. These estimates can be used to guide instruction. Cumulative Tests support instructional planning using estimates of response probabilities for thousands of items even though any given student will not have responded to all of those items.

### Forecasting Standards Mastery with a Cumulative Test

Benchmark assessments and other types of local tests are often used to forecast standards mastery on criterion measures such as statewide tests. In the typical case, a series of achievement levels are specified by segmenting the continuous ability distribution for the criterion measure into categories. For example, the ability distribution for a statewide test might be segmented into four levels: Falls far below the standard, approaches the standard, meets the standard, and exceeds the standard. Cut points are set for each level indicating the scale score and corresponding percentile rank separating one achievement level from the next level. Forecasting may be initiated by segmenting the distribution for the forecasting measure (e.g. a benchmark test) into categories corresponding to those used on the statewide test. This can be accomplished through equipercentile equating, which is implemented by setting the cut points at the scores at which percentile ranks for the forecasting measure are equal to the percentile ranks for the criterion measure.

When equipercentile equating is used with district forecasting measures each administered in a single testing session, separate cut points must be set for each district. When the number of districts is large, equipercentile equating may be implemented hundreds of times. When a Cumulative Test is used for forecasting, there is only one forecasting ability distribution. Thus, equipercentile equating is implemented only once. Moreover, since the sample of students participating in the Cumulative Test is likely to be very large, measurement precision is likely to be higher than would be the case when an ability distribution for a test administered in a single district is used for forecasting.

Equipercentile equating provides a sufficient approach for setting cut points when forecasting is based on a single assessment. However, forecasting often involves multiple assessments occurring over an extended time span. For example, forecasting may be conducted for each of a series of benchmark assessments occurring at different points in the school year. Under these conditions, cut points must be adjusted to reflect expected growth during the school year. This may be accomplished by regressing the ability score on time. For example, in order to establish the appropriate cut score for a Cumulative Test, the estimated ability yielded by the test will be regressed on the number of days between the initial assessment and the subsequent assessment as illustrated in the following equation:

y′ᵢ=a|btᵢ;

where tᵢ is the number of days between testing time points, y′ᵢ is the predicted ability score at time tᵢ, a is the intercept, and b is the slope.

Given the many advantages of the cumulative assessment paradigm, it is reasonable to expect that the use of Cumulative Tests will expand in the years ahead. The availability of technology in schools is likely to play an important role in that expansion. As technology availability increases, assessments providing information to guide instruction can be expected to become an integral part of the instructional process. As this increase occurs, Cumulative Tests, which are designed to guide instruction, can be expected to take their place as a new and useful assessment tool uniquely positioned to serve changing educational needs that have emerged as the world has entered the information age.

It will be obvious to those having skill in the art that many changes may be made to the details of the above-described embodiments without departing from the underlying principles of the invention. The scope of the present invention should, therefore, be determined only by the following claims.

1. A computer-implemented method for analysis of educational assessment data comprising the steps of:
defining a class of test items corresponding to a selected subject and grade level;
selecting an extended time span, wherein the extended time span is one during which at least two discrete tests were administered to students, each of the discrete tests comprising test items among the defined class of test items;
acquiring stored test data resulting from administration of the discrete tests, the acquired test data including, for each test item of each discrete test, an identifier for each examinee who took the discrete test that included the test item, and an indicator of the corresponding examinee's response to the test item;
including in the acquired test data all examinee responses to a given test item, notwithstanding inclusion of the test item in more than one of the discrete tests, thereby increasing the available number of examinee responses to improve the corresponding item parameter estimations;
combining the acquired test data to form a single cumulative test covering the extended time span;
estimating or acquiring item response theory (IRT) parameters for modeling each of the test items included in the cumulative test;
combining the IRT parameters so as to form a single IRT measurement model of the cumulative test; and
utilizing the measurement model of the cumulative test to form a first estimate of proficiency for at least one of the students for the extended time span, based on the student's responses in the discrete tests.

2. The method of claim 1 and further comprising:
assuming a predetermined form of ability distribution for the selected subject and grade level by fixing selected mean and standard deviation values for the acquired test data;
using IRT, estimating a first ability score for a selected examinee based on the cumulative test to provide a measurement of ability in the selected subject and grade level for the extended time span.

3. The method of claim 2 and further comprising:
subsequently repeating the foregoing steps to build a second cumulative test for the selected subject and grade level;
estimating a second ability score for the student based on the second cumulative test; and
comparing the second ability score to the first ability score to measure student growth over time.

4. The method of claim 1 wherein the extended time span comprises a school year.

5. The method of claim 1 including acquiring the test data from multiple schools.

6. The method of claim 1 and further comprising scaling the cumulative test by selecting desired statistical properties and then identifying a transformation so as to achieve the desired statistical properties in a distribution of scaled proficiency estimates for the cumulative test.

7. The method of claim 5 wherein the desired statistical properties include at least one of a mean and a standard deviation.

8. The method of claim 7 wherein the transformation is linear.

9. The method of claim 1 including combining benchmark assessments and formative assessments in the cumulative test to improve measurement precision.

10. A computer-implemented method for analysis of educational assessment data comprising the steps of:
defining a class of students corresponding to a selected subject and age or grade level; selecting an extended time span, wherein the extended time span is one during which at least two discrete tests in the selected subject were administered to the class of students;
acquiring stored test data resulting from administration of the discrete tests, the acquired test data including, for each test item of each discrete test, an identifier for each examinee who took the discrete test that included the test item, and an indicator of the corresponding examinee's response to the test item;
combining the acquired test data to form a single cumulative test covering the extended time span;
forming a single item response theory (IRT) based measurement model of the cumulative test; and
applying the measurement model of the cumulative test so as to determine a proficiency score of at least one of the students for the extended time span, based on the student's responses in the discrete tests.

11. The method of claim 10 including:
building a first cumulative test after administrating a first benchmark test, based on results of at least the first benchmark test;
scoring a student's performance based on the first cumulative test;
building a first cumulative test after administrating a first benchmark test to the class of students, based on results of at least the first benchmark test;
scoring a student's performance based on the first cumulative test;
building a second cumulative test after administrating a second benchmark test to the class of students, based on results of at least the first and second benchmark tests;
scoring the student's performance based on the second cumulative test; and
measuring the student's progress based on comparing the first and second scores.

12. The method of claim 10 and further comprising:
assuming a predetermined form of ability distribution for the selected subject and grade level by fixing selected mean and standard deviation values for the acquired test data;
using IRT, estimating a first ability score for a selected examinee based on the cumulative test to provide a measurement of ability in the selected subject and grade level for the extended time span.

13. The method of claim 12 and further comprising:
subsequently repeating the foregoing steps to build a second cumulative test for the selected subject and grade level;
estimating a second ability score for the student based on the second cumulative test; and
comparing the second ability score to the first ability score to measure student growth over time.

14. The method of claim 12 wherein the extended time span comprises at least one semester.

15. The method of claim 12 including acquiring the test data from multiple schools.

16. The method of claim 12 and further comprising scaling the cumulative test by selecting desired statistical properties and then identifying a transformation so as to achieve the desired statistical properties in a distribution of scaled proficiency estimates for the cumulative test.

17. The method of claim 16 wherein the desired statistical properties include at least one of a mean and a standard deviation.

18. The method of claim 17 wherein the transformation is linear.

19. The method of claim 18 including combining benchmark assessments and formative assessments in the cumulative test to improve measurement precision.

20. The method of claim 17 including regressing the proficiency score on a number of days between testing time-points to determine achievement level cut-points.
